(19) United States
(12) Patent Application Publication
(10) Pub. No.: US 2023/0146205 A1
(43) Pub. Date: May 11, 2023

(54) PLASTIC-DERIVED MESOPHASIC CARBON

(71) Applicant: UNIVERSITY OF UTAH RESEARCH FOUNDATION, Salt Lake City, UT (US)

(72) Inventors: Joshua R. Malzahn, Salt Lake City, UT (US); Eric G. Eddings, Salt Lake City, UT (US)

(21) Appl. No.: 17/981,133

(22) Filed: Nov. 4, 2022

Related U.S. Application Data
(60) Provisional application No. 63/276,483, filed on Nov. 5, 2021.
(60) Provisional application No. 63/326,207, filed on Mar. 31, 2022.

(51) Int. Cl. C10B 53/07; C10B 57/00; C10B 57/02

(52) U.S. Cl. CPC C10B 53/07; C10B 57/005; C10B 57/02

(57) ABSTRACT

Methods and systems for producing mesophasic (between liquid and solid phases) carbon materials from plastic waste. The method and system includes a 2-stage pyrolysis reactor, including first and second pyrolysis stages where a carbon feedstock material is subjected to pyrolysis. The first pyrolysis stage may subject the carbon feedstock material to pyrolysis at a first temperature in a range of 500° C. to 700° C., and the second pyrolysis stage may operate at a second temperature in a range of 800° C. to 1000° C., providing secondary gas phase reactions (SGR). A residence time of the carbon feedstock material in the reactor may be no more than 10 seconds. After pyrolysis and SGR, a sparging and thermal treatment stage may convert pyrolysis tar products to an anisotropic pitch product suitable for use in production of carbon fiber or bulk graphite for use in fabrication of graphite electrodes.

### CROSS-REFERENCE TO RELATED APPLICATIONS

The present application claims the benefit of U.S. Provisional Patent Application No. 63/276,483 filed Nov. 5, 2021 and entitled PLASTIC-DERIVED MESOPHASIC CARBON, as well as U.S. Provisional Patent Application No. 63/326,207 filed Mar. 31, 2022 and entitled PLASTIC-DERIVED MESOPHASIC CARBON, each of which is herein incorporated by reference in its entirety.

### STATEMENT REGARDING FEDERALLY SPONSORED RESEARCH

This invention was made with government support under grant DE-FE0031880 awarded by the Department of Energy. The government has certain rights in this invention.

### BACKGROUND

### Technical Field

The present application relates to processes for producing carbon fiber, bulk graphite for graphite electrodes and similar high value carbon materials from intermediate materials which are mesophasic and anisotropic, where the source materials for such intermediate materials include waste plastic materials.

### Relevant Technology

While some research has been done to produce carbon fiber from coal, or even perhaps from select plastics, none of this work has been able to produce carbon fibers from plastics, with properties typical of high-modulus carbon fibers that are needed for the aerospace, automobile and other industries using composite materials. To produce high-modulus carbon fibers, mesophase carbon materials are needed, which are currently only available through coal tar and petroleum pitch as starting materials. Mesophase carbon materials are also useful in the production of bulk graphite that is used in the production of electrodes for batteries.

Accordingly, there are a number of problems and disadvantages still to be addressed in the art. It would be particularly advantageous if processes were developed that could turn waste plastic materials into mesophase anisotropic carbon materials that could be used to produce such high value carbon materials.

### BRIEF SUMMARY

One aspect of the present disclosure is directed to a pyrolysis reactor and thermal treatment system and method, for use in producing mesophasic (between liquid and solid phases, with highly structured, anisotropic characteristics) carbon materials, such as can be used to produce high quality, high-modulus carbon fibers, and/or bulk graphite materials. The pyrolysis reactor has two stages, where in the first stage (e.g., conducted in a stainless steel pyrolysis reactor or reactor portion) the feedstock (e.g., including plastic material, such as waste plastic, such as polystyrene, LLDPE, other polyethylenes, polypropylene, or similar plastic feedstock), which may be provided alone, or provided in combination with another material, such as coal is initially pyrolyzed (under an inert gas atmosphere such as nitrogen, argon or the like) at a relatively lower temperature (e.g. about 600° C., such as from 500° C. to 700° C., or 550° C. to 650° C.). Gas-phase reactions during pyrolysis lead to cracking and ring-condensation, which can modify the chemistry of the products. After the first stage pyrolysis, the pyrolysis vapors are carried into the second reactor stage (e.g., either a separate second reactor, or a second portion of a single reactor). The second reactor stage can be formed of a different material (e.g., quartz) relative to the first reactor stage, and operates at a higher temperature (e.g. about 900° C., such as from 800° C. to 1000° C., or 850° C. to 950° C.) as compared to the first reactor stage. In an embodiment, the waste plastic material may initially include an aromatic structure (e.g., such as in polystyrene).

The generated pyrolysis vapors undergo secondary gas-phase reactions (SGR) with a controlled residence time (e.g., which may be relatively short, such as no more than 10 seconds, or no more than 5 seconds). At the end of the reactor system one or more chilled containers may be used to capture the condensable pyrolysis products. While applicant's current lab-scale system on which examples have been conducted is a batch reactor, in future scale-up designs, the system can be modified to allow for continuous feed. A continuous feed system will also allow for easy control of the pyrolysis vapor residence time, which can be controlled by the inert gas flowrate and reactor geometry. As noted above, pyrolysis vapor residence time may be relatively short, such as no more than 10 seconds, no more than 5 seconds, no more than 4 seconds, or no more than 3 seconds.

As will be appreciated by those of skill in the art, a continuous feed process refers to a flow production method where such process or method proceeds without substantial interruption. Continuous processes are defined as such because the materials being processed are continuously in motion, undergoing chemical reactions or subject to mechanical, heat or other treatment. Such continuous processes are contrasted with batch processes, which will also be familiar to those of skill in the art. By way of example, a continuous process may operate 24 hours a day, seven days a week, with infrequent maintenance shutdowns, such as semi-annual or annual.

In any case, the present method and system has the potential to create highly aromatic liquid intermediate products suitable for production of mesophase carbon materials, which can in turn be used to produce high-value products, such as bulk graphite for graphite electrodes for batteries or suitable for melt spinning high-modulus carbon fibers for composites. By way of example relative to the elastic modulus of various grades of carbon fibers, exemplary standard modulus carbon fibers may exhibit a fiber modulus of 30-40 msi (e.g., about 200-275 GPa), and a tensile strength of about 500-700 ksi (3.5-4.8 GPa). Higher intermediate modulus carbon fibers may have a somewhat higher fiber modulus, e.g., about 40-50 msi (e.g., about 275-345 GPa), with a tensile strength of about 800 to 1000 ksi (5.5-6.9 GPa). Even higher, so called high-modulus carbon fiber may have a fiber modulus of at least 50 msi (345 GPa), or at least 55 msi (about 380 GPa) (e.g., 50-60 msi, about 345-415 GPa). Such fibers may have a somewhat reduced tensile strength, e.g., of 600-700 ksi (4.1-4.8 GPa). Even higher fiber modulus values are possible, e.g., even greater than 100 msi (690 GPa), although with a further trade off in reduced tensile strength (e.g., 400 to 500 ksi, about 2.7-3.5 GPa). Such values are merely exemplary, and it will be appreciated that carbon fiber having any of a wide variety of modulus and tensile strength values (those noted above and others) may be possible. The present processes provide for production of mesophasic, anisotropic intermediate materials sourced and formed from waste plastic materials, which can be used to produce relatively high modulus carbon fiber, where such is desired.

By way of example, applicants 2-step pyrolysis process for feedstock streams including plastic (e.g. polystyrene or others) can yield aromatic liquid intermediates suitable for producing mesophase carbon. By using a low-value waste plastic feedstock to produce mesophase carbon materials for high-value products, the presently contemplated processes provide increased sustainability and upcycling potential for such waste plastic materials.

In an embodiment, the feedstock can include coal, petroleum pitch, or another material (e.g., asphaltenes, etc.), in combination with a plastic material (e.g., waste plastic), such as polystyrene, polyethylene (e.g., LLDPE, LDPE, HDPE), polypropylene, polyethylene terephthalate (PET), polyurethane, or the like. In an embodiment, the waste plastic comprises aromatic groups, such as polystyrene, or PET. For such combinations, the fraction of plastic included in the feedstock to the pyrolysis process may be at least 1%, at least 2%, at least 3%, at least 4% or at least 5%, such as from 5% to 95% by weight, from 10% to 90%, from 5% to 50%, from 5% to 40%, from 5% to 30%, from 5% to 20%, or from 10% to 20%, such as 5%, 10%, 15%, 20%, 25%, 30%, 35%, 40%, 45%, 50%, 55%, 60%, 65%, 70%, 75%, 80%, 85%, 90%, or 95% by weight of the feedstock introduced to the pyrolysis process. The fraction of coal, petroleum pitch, or other material may similarly range from 1% to 99%, or from 5% to 95%, from 10% to 90% by weight, from 50% to 95%, from 60% to 95%, from 70% to 95%, from 80% to 95%, or from 80% to 90%, such as 5%, 10%, 15%, 20%, 25%, 30%, 35%, 40%, 45%, 50%, 55%, 60%, 65%, 70%, 75%, 80%, 85%, 90%, or 95% by weight of the feedstock introduced to the pyrolysis process. Additional ranges may be defined between any of such provided values. For example, in an embodiment, the plastic content of the feedstock may be from 5% to 30% by weight, from 5% to 25% by weight, or from 10% to 20% by weight.

After pyrolysis, the resulting materials are thermally treated under conditions where the desired mesophasic tar pitch materials can result. In an embodiment, before such thermal treatment, the produced materials may be subjected to an inert gas flow (e.g., nitrogen) to help purge low molecular weight species, which can be a crucial step in creating mesophase tar pitch from such materials. Once so purged, the remaining material may undergo thermal treatment. Such thermal treatment may involve heating the pyrolysis materials to a temperature and time where the desired mesophasic tar pitch materials can form. By way of example, such thermal treatment may involve heating to at least 400° C., such as from 400 to 500° C., or 400 to 450° C. (e.g., about 425° C.). Where a catalyst is employed during such step, a significantly lower temperature may be possible (e.g., no more than 350° C., no more than 300° C., no more than no more than 250° C., or no more than 200° C., such as 80° to 200° C.), reducing energy consumption. Such thermal treatment may occur for a residence time of at least 1 hour, such as 1-5 hours, or 3-5 hours. Use of a catalyst may also be possible during the pyrolysis steps (e.g., within the first or second reactor stage). By way of example, particularly for catalysts employed during the second pyrolysis stage, it may be possible to reduce the pyrolysis temperature (e.g., to less than 900° C., or even less than 800° C. Whether temperature is reduced or not, the use of catalysts within such a stage may aid with aromatic compound formation, particularly from olefinic plastics such as polyethylenes and polypropylene, and thereby increase overall mesophase yields from these waste plastic materials.

The resulting materials may exhibit mesophasic, anisotropic characteristics, suitable for use in melt spinning of carbon fibers, or suitable for use as bulk graphite materials, e.g., such as may be used in fabrication of a graphite electrode for a lithium-ion or other battery. Such resulting condensed anisotropic pyrolysis products may have an either a raw or weighted optical texture index (OTI) of at least 10, at least 20, or at least 30 (on a scale of 0-40), and/or may be such that the condensed anisotropic pyrolysis product includes at least 50%, at least 60%, or at least 70%, such as 70-80% mesophase material. Such condensed anisotropic pyrolysis products may exhibit a softening temperature of 350° C., so as to be suitable for melt spinning.

Features from any of the disclosed embodiments may be used in combination with one another, without limitation. For example, any of the compositional or other limitations described with respect to one embodiment may be present in any of the other described embodiments. In addition, other features and advantages of the present disclosure will become apparent to those of ordinary skill in the art through consideration of the following detailed description and the accompanying drawings.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 shows a schematic view of an exemplary two-stage fixed bed pyrolysis reactor system.

FIG. 2 shows a schematic view of an exemplary thermal treatment stage of the present process, for upgrading tar from the pyrolysis reactor system, to pitch.

FIGS. 3A-3B show effects plots on OTI for effect A (SGR temperature) and effect B (SGR residence time), respectively, for various types of coal.

FIGS. 4A-4B show effects plots on oxygen content for effect A (SGR temperature) and effect B (SGR residence time), respectively, for various types of coal.

FIGS. 5A-5B show effects plots on mesophase content (%) for effect A (SGR temperature) and effect B (SGR residence time), respectively, for various types of coal.

FIGS. 6A-6C show effects plots on OTI for effect A (plastic type) and effect B (plastic %) and effect C (SGR Temperature), respectively, for blends of plastic and coal.

FIG. 7 shows a graphical comparison of integrated FTIR absorbance values for oxygen content in co-pyrolysis (plastic and coal) tar samples. Error bars are 95% confidence intervals calculated from replicate samples.

FIG. 8 shows relative fractions of the various hydrogen types described in Table 7 for the LLDPE/coal co-pyrolysis tar samples.

FIG. 9 shows relative fractions of the various hydrogen types described in Table 7 for the HIPS/coal co-pyrolysis tar samples.

FIG. 10 shows values of interested from H¹ NMR data for the LLDPE/coal tar samples. The error bars indicate the 95% confidence intervals calculated based on the replicates.

FIG. 11 shows values of interested from H¹ NMR data for the HIPS/coal tar samples. The error bars indicate the 95% confidence intervals calculated based on the replicates.

FIG. 12 shows derivative of height displacement curves measured by DMA to indicate softening points of pitch samples prepared from the HIPS/coal samples. The max displacement rate's temperature is assumed to be the sample softening point.

FIG. 13 shows microscopy analysis results for LLDPE/coal pitch samples. The error bars indicate the 95% confidence intervals calculated based on the replicates.

FIG. 14 shows microscopy analysis results for HIPS/coal pitch samples. The error bars indicate the 95% confidence intervals calculated based on the replicates.

FIG. 15 shows derivative of height displacement curves measured by DMA to indicate softening points for the U-20-PS-900 pitch samples created at different thermal treatment times (3, 4, and 5 hours, respectively).

FIG. 16 shows subplots comparing the LLDPE/coal experimental results vs. the precited values based on a linear combination of the pure component values. The error bars indicate the 95% confidence intervals calculated based on the two replicates.

FIG. 17 shows subplots comparing the HIPS/coal experimental results vs. the precited values based on a linear combination of the pure component values. The error bars indicate the 95% confidence intervals calculated based on the two replicates.

### DETAILED DESCRIPTION

### Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising,” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

Some ranges may be disclosed herein. Additional ranges may be defined between any values disclosed herein as being exemplary of a particular parameter. All such ranges are contemplated and within the scope of the present disclosure. Unless indicated otherwise, percentages are by weight.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

All numerical quantities in this description indicating amounts of material or conditions of reaction and/or use are to be understood as modified by the word “about” in describing the broadest scope of the disclosure. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements. By way of example, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Also, unless expressly stated to the contrary, description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

As used in the specification, a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

### Examples

A two-stage pyrolysis reactor was used to subject plastic pyrolysis vapors to secondary gas-phase reactions (SGR) for a controlled residence time to create plastic-tars, which can potentially be transformed into a value-added material (plastic tar-pitch) suitable for producing high-modulus carbon fiber from waste plastic streams. Preliminary tests have been performed by applicant using this technology on linear low-density polyethylene (LLDPE) and polystyrene (PS).

A primary goal for the described work was to investigate the efficacy of the technology for dealing with a variety of waste plastic mixtures, and what that impact may be on final yield and quality of mesophase pitch, for validation purposes. The present invention addresses one challenge of upcycling waste plastic in that it may not be necessary to physically separate plastics by their type prior to processing as described herein. In another embodiment, separation of plastics may be beneficial, e.g., to increase the fraction or yield of desired mesophase pitch materials that can be used to produce carbon fiber, bulk graphite, etc.

To applicant's knowledge, there is little if any literature regarding the use of pyrolysis of plastics to create plastic-derived tars and pitch for carbon fiber production. For comparative purposes, some results for coal tar and coal tar pitch that were obtained by applicant under similar operating conditions have been used to provide insights relative to the aims of the present disclosure.

Single-use plastics commonly found in plastic waste can, in theory, be produced from over a dozen polymer families. However, it is estimated that nearly 90 percent by mass of all single-use plastics are produced from just a few polymers: polypropylene (PP), various grades of polyethylene (HDPE, LDPE, and LLDPE), and polyethylene terephthalate resin (PET). Common types of plastics found in plastic waste include PP, HDPE, LDPE, LLDPE, PET, PS, PVC, and mixtures of others; with packaging and textiles being among the main sources of waste plastics.

Various virgin plastic materials were pyrolized. Solid, liquid, and gas yields were determined for each plastic type, the liquid products were analyzed by Fourier-transform infrared spectroscopy (FTIR) to identify major chemical properties, such as oxygen content, aliphatic content, and aromatic content; and gas chromatography was used to identify the major gaseous products.

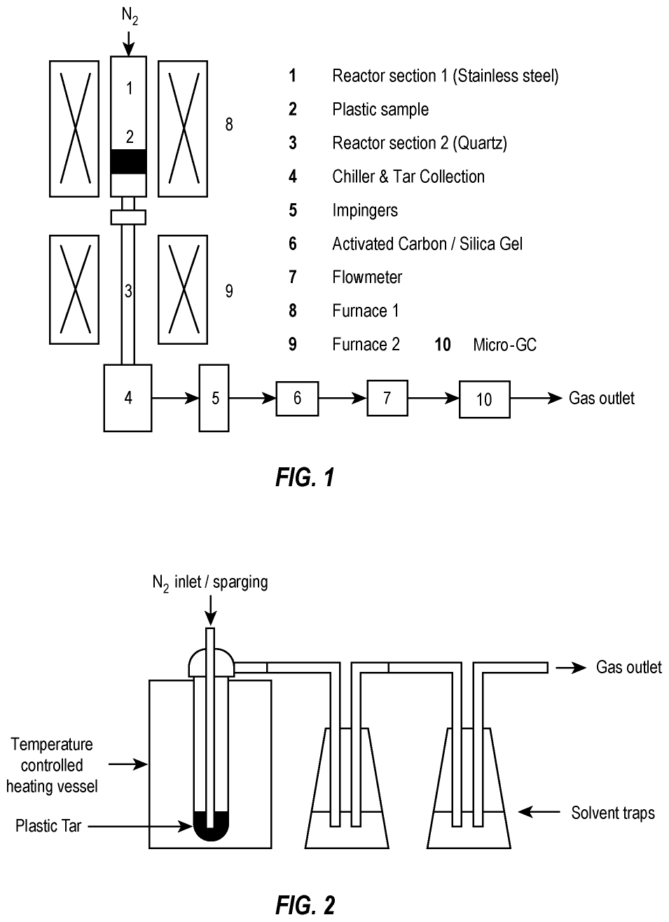

HDPE, LDPE, LLDPE, PP, PET and PS were individually tested to create plastic-tars and evaluate their performance under proposed pyrolysis conditions. Each plastic was subject to pyrolysis in a two-stage fixed-bed reactor (batch system) as depicted in FIG. 1. The reactor included two stages, where the plastic 2 was introduced into reactor stage 1 (e.g., a 2″ OD 316 stainless steel tube), and the volatilized tar vapors were sent through the second reactor stage 3. Reactor stage 1 was joined to the second reactor stage 3 by a flange with a copper gasket. The condensable pyrolysis volatiles were collected in a series of containers 4 and impingers 5. Most tar was captured within the first two containers 4. The containers 4 and impingers 5 were chilled to −15° C. The glass impingers 5 were used to trap any residual heavy tar. Two acrylic tubes 6 in series, filled with activated carbon and silica gel, respectively, were used to clean the gas of any remaining light tar and moisture before passing through a gas flow meter 7 and micro-gas chromatograph 10. Furnaces 8 and 9 were provided for heating the reactor stages 1 and 3 to the desired temperatures

For each test, 100 g of plastic was loaded into the reactor stage 1 with fine quartz wool above and below the plastic to keep it in place. As plastic pyrolysis vapors evolved from the plastic bed, they were carried into the second reactor stage 3 by the nitrogen carrier gas (flow rate 158 ml/min). Reactor stage 1 was heated to 600° C. and second reactor stage 3 was heated to 900° C., at which temperature the tar vapors are prevented from condensing, and where cracking and ring-condensation reactions are enabled to occur.

The micro-GC 10 (Variant 490) included two columns, where column 1 was a Molecular Sieve (Mol-Sieve) 5A PLOT column that can detect H₂, CO, N₂, O₂, and CH₄. Column 2 was a PoraPLOT Q PLOT that can detect CH₄, CO₂, and light hydrocarbons (C₁-C₃). Each column was controlled independently, and the operation temperature range was between 30° C. to 180° C. The injection volume was between 1 μL to 10 μL (software selectable) and the detector was a Thermal Conductivity Detector (TCD). The detection limits for Columns 1 and 2 were 10 ppm and 1 ppm, respectively. The carrier gas was UHP Argon for Column 1, and UHP Helium for Column 2. The gas stream coming out of the reactor was sampled by the micro-GC 10 every three minutes. A multi-species calibration gas (cal-gas) was used to enable identification of the species present in the gas phase of the heat-treated samples.

The collected plastic-tar samples were dissolved in tetrahydrofuran (THF) and then subsequently vacuum-filtered through 1.5-μm pore filter paper (Whatman, 934-AH) to remove any THF-insoluble material (coke). The filtered plastic-tar solutions were then distilled under nitrogen at 65° C. to remove THF. A portion of the distilled tar samples was saved for characterization.

Table 1 below summarizes the experimental results obtained from the pyrolysis process in the two-stage reactor, from 100 g of each of the various tested plastics.

TABLE 1

| | | | Solid products ^{b} | | Other deposits ^{c} | | | |
|---|---|---|---|---|---|---|---|---|
| | | | Avg mass | | Avg mass | | | |
| | Liquid products ^{a} | | collected | | collected | | | |
| Plastic | Avg mass | | in quartz | | in other | | Gaseous species ^{d} | |
| type | collected, g | (%) | tube, g | (%) | components, g | % | Mass, g | % |
| PP | 28 | 28 | 0.78 | 0.78 | 3.3 | 3.3 | 67.92 | 67.92 |
| LDPE | 27.7 | 27.7 | 0.82 | 0.82 | 10.5 | 10.5 | 60.98 | 60.98 |
| HDPE | 29.6 | 29.6 | 1.62 | 1.62 | 11.2 | 11.2 | 57.58 | 57.58 |
| LLDPE | 24.1 | 24.1 | 0.56 | 0.56 | 11.9 | 11.9 | 63.44 | 63.44 |
| PET* | 14 | — | 10 | — | — | — | — | — |
| PS | 85 | 85 | 4 | 4 | 1 | 1 | 10 | 10 |

^{a} Represents the mass and mass % of the material loaded that was collected as liquid products (includes tars and waxes) after pyrolysis.
^{b} Represents the mass and mass % of the material loaded that stayed in the quartz reactor as carbonaceous material after pyrolysis
^{c} Corresponds to the mass and mass % of the material loaded that was deposited in other components of the system such as fittings and tubing (consists of mostly waxy material).
^{d} Corresponds to the mass and mass % of the material loaded that was converted to gaseous species. These numbers were obtained by difference. For mass of gaseous species: 100 g minus mass reported in a + b + c. For % of gaseous species: 100 minus % reported in a + b + c.
*Results for the test with PET were incomplete. The system became clogged, as the bottom section of the quartz tube was quenched to condense and collect volatile species and big chunks of wax resulting from the PET pyrolysis were deposited and solidified quickly in the quartz tube. Once the reactor pressure increased to over 30 psi the test was stopped.

Full experimental results for PET were not obtained, as noted above. Modifications to the reactor configuration to prevent or minimize condensation and precipitation could be made, to allow processing of PET. It is noted that the PET monomer (MW: 222.2 g/mol) is much heavier than the PE and PP monomers (MW: 28 and 42.1 g/mol respectively); even much heavier than the PS monomer (MW: 104.1 g/mol), which could be an indication of the propensity of this material to create clogs caused by heavy waxes present, with the employed reactor configuration.

Experimental results were obtained for polystyrene (PS), in an effort to identify a species that produced significantly more liquid under the tested conditions. As shown in Table 1, the PS produced substantially more liquid product (85% of the initial plastic mass) than the other tested plastics. The basic aromatic structure of PS may aid in enhancing mesophase pitch production. With modifications to reduce reactor clogging, PET (which includes a phthalate aromatic group) may provide similar enhanced mesophase pitch production.

The information recorded by the micro-GC was retention time and area for each gaseous species, and the area was converted to concentration (in ppm) through use of a multi-species calibration gas. The gaseous species detected were hydrogen (H₂) in Channel 1; and methane (CH₄), carbon dioxide (CO₂), ethylene (C₂H₄), ethane (C₂H₆), propylene (C₃H₆) and propane (C₃H₈) in Channel 2. Table 2 illustrates the peak concentrations (max values) of the gaseous species present in each type of plastic processed. Individual concentration plots for each species were also obtained.

TABLE 2

| | Species | Retention | Maximum concentration | | | |
|---|---|---|---|---|---|---|
| Micro-GC | detected in | time | detected for each plastic (ppm) | | | |
| channel | gas-phase | (minutes) | PP | LDPE | HDPE | LLDPE |
| 1 | H₂ | 0.84 | 179900 | 188700 | 200470 | 175095 |
| 2 | CH₄ | 0.31 | 316600 | 285500 | 275420 | 241200 |
| 2 | CO₂ | 0.35 | 24330 | 28450 | 31710 | 21590 |
| 2 | C₂H₄ | 0.39 | 147500 | 212420 | 204000 | 183450 |
| 2 | C₂H₆ | 0.44 | 29200 | 33070 | 32170 | 29700 |
| 2 | C₃H₆ | 0.95 | 69500 | 14900 | 48000 | 43500 |
| 2 | C₃H₈ | 0.99 | 1950 | 1670 | 1760 | 1424 |

FTIR results were also obtained for the different plastic-derived tars. Aliphatics, fatty acids and aromatics, and aromatics were clearly identified in each plastic-tar sample.

Aliphatic absorbance was observed in the wavelength range of 3000 to 2800 cm⁻¹. Oxygen functional groups are typically indicated in the wavelength ranges of 1800 to 1650 and 1300 to 1000 cm⁻¹. Fatty acids can be present in plastic wax, and elemental analysis of virgin plastics has shown the presence of incidental oxygen at around 0.20% by mass in LDPE and HDPE.

Aromatic absorbance is observed in the wavelength range of 1600 to 1300 cm⁻¹ (aromatic C═C, CH₃-aromatic, CH₂-aromatic) and in the range of 650 to 950 cm⁻¹, specifically isolated aromatic H's at 900 to 860 cm⁻¹), 2 adjacent aromatic H's at 850-800 cm⁻¹, 3 adjacent aromatic H's at 790 to 770 cm⁻¹, 4 adjacent aromatic H's at (750 to 740 cm⁻¹), and 5 adjacent aromatic H's at about 695 cm⁻¹.

After collecting the liquid pyrolysis products as described above, they were further treated in a simple thermal treatment process (mixing/sparging) to facilitate the conversion of the liquid products into an anisotropic mesophase pitch material. Such anisotropic mesophase pitch materials may be suitable for use in manufacture of high-modulus carbon fiber, or bulk graphite (e.g., for battery electrode materials). The resulting solid mesophase pitch products were analyzed by dynamic mechanical analysis (DMA), which identifies the samples' softening points.

As noted, the plastic-tar samples were thermally treated before determining their respective anisotropy formation and quality. The samples were thermally treated in a small stainless-steel tube reactor with a sparging tube for mixing (see FIG. 2). A nitrogen flow rate of 250 ml/min was maintained to help purge low molecular weight species, which can be a crucial step in creating mesophase tar pitch from such materials. Samples were heated at 150° C. for 30 min to liberate any residual THF, then were heated to about 425° C. at 10° C./min and were soaked at the temperatures listed in Table 3 for 3 h. In some cases, as described hereafter, treatment was for longer, such as 4 h, or 5 h (e.g., 3 to 5 hours). Two solvent traps (with toluene and isopropyl alcohol) were used to help capture the distilled THF and light tar/gas species. Table 3 summarizes the experimental results obtained in the pitch upgrading process. The reported pitch yield is based on 100 g of the plastic initially processed through the pyrolysis reactor.

TABLE 3

| | Temperature | Mass of | Pitch | | DMA |
|---|---|---|---|---|---|
| Plastic | in sparging | pitch | yield | Pitch | Soft. Point |
| type | reactor ° (C.) | created (g) | (%) | characteristic | (C) |
| PP | 431 | 0.46 | 0.46 | Solid (black | Doesn't |
| | | | | shiny) | melt |
| PP | 424 | 0.46 | 0.46 | Solid (black | Doesn't |
| | | | | shiny) | melt |
| PP | 423 | 0.74 | 0.74 | Solid (black | Doesn't |
| | | | | dull-shiny) | melt |
| LDPE | 418 | 1.4 | 1.4 | Waxy (sticky) | — |
| LDPE | 442 | 0.64 | 0.64 | Dry paste | Soft pellet |
| LDPE | 453 | 0.45 | 0.45 | Solid (black) | Doesn't |
| | | | | | melt |
| HDPE | 419 | 1.7 | 1.7 | Waxy (sticky) | — |
| HDPE | 440 | 0.5 | 0.5 | Dry-paste | — |
| | | | | material | |
| HDPE | 451 | 0.45 | 0.45 | Dry-paste | Soft pellet |
| | | | | material | |
| LLDPE | 418 | 1 | 1 | Waxy (sticky) | — |
| LLDPE | 440 | 0.27 | 0.27 | Dry-paste | Soft pellet |
| | | | | material | |

As shown, pitch yields for polyethylene and polypropylene were quite low (around 0.5%) and it was only possible to obtain solid pitch material from two types of tested plastics, PP at 423-431° C. and LDPE at 453° C.

In general, for LDPE, HDPE and LLDPE the upgraded material was either waxy or a solid paste (not a solid powder).

Wax recovery from pyrolysis of plastics such as LDPE and HDPE are believed to include two distinct fractions, light waxes (up to C₄₀), easily dissolved in paraffin standards with a boiling point between 343 and 525° C.; and heavy waxes, with a higher boiling point. These waxes with higher boiling points may explain why solid material did not result when upgrading tars at 442° C. for LDPE and at 451° C. for HDPE.

In addition to selection of plastic types, pyrolysis temperature, and gas residence time, the use of catalysts during such a thermal treatment phase may also play an important role in pyrolytic conversion of plastic waste to mesophase pitch materials as contemplated herein. In an embodiment, one or more catalysts may be employed (e.g., any of various aluminosilicate zeolite catalysts, a phosphoric acid functionalized activated carbon catalyst for aromatization, and/or strongly protonic homogenous “solid acid catalysts”, such as used for hydrolysis and esterification (e.g., activated carbon catalysts functionalized with sulfuric acid, and/or triflic acid, etc.). Any such catalyst may incorporate magnetite or another magnetic material to facilitate catalyst recovery. Use of catalysts may reduce energy consumption (e.g., by 40-65%), by reducing the temperature needed during the thermal treatment phase of the process.

In the pyrolysis of plastic wastes, the increase in temperature and gas residence times result in a rapid increase in gas yields from the enhanced cracking reactions and, correspondingly, in a decrease in the oil/wax yield. In general, high temperature favors the production of less waxy and more oily compound production, attributed to the conversion of long-chain paraffins/olefins to shorter molecules. In the presently described work, the pyrolysis temperature and gas residence time in the secondary gas reaction zone were optimized previously when working with coal tars and PS tars.

The pyrolysis of polyolefins, including LDPE, HDPE, and PP, typically produces a liquid oil with a significant fraction of aliphatics (alkanes and alkenes). In other words, PE and PP produce pyrolysis oils with more aliphatic compounds, while PS generates higher aromatic hydrocarbons. FTIR results included confirm such. Such aliphatic materials could be converted to aromatic structures through use of an aromatization catalyst (e.g., any of various zeolites, and/or a phosphoric acid functionalized activated carbon catalyst).

Plastic pyrolysis and/or thermal treatment in the presence of catalysts, particularly an aluminosilicate zeolite such as HZSM-5 and/or a phosphoric acid functionalized activated carbon catalyst may tend to produce remarkably more aromatic and polycyclic aromatic hydrocarbons due to the enhanced cracking reactions, compared to the uncatalyzed pyrolysis process. The use of such catalysts during either pyrolysis and/or thermal treatment may therefore aid in producing a greater fraction of aromatic structures, particularly where the feedstock may include a significant fraction of polyolefins.

The promising results obtained for PS, however, indicates that mixtures that involve PS may be quite interesting and could produce significantly higher yields of desirable aromatic intermediate tars and pitch, even without the need for an aromatization catalyst. Of course, a catalyst could be used, to further increase the production of desirable aromatic intermediate materials, with any feedstock.

The pitch samples created in the sparging system without use of any catalyst were tested for their melting points by differential mechanical analysis (DMA). Pitch samples were pressed into a puck and placed in the DMA to detect mechanical displacement (i.e., softening or melting) upon heating. DMA measures the displacement, and the derivative of the displacement can show a distinct minimum, where the maximum melting occurs (i.e. melting or softening point). Mesophase pitch as useful in formation of high modulus carbon fiber should have a melting point of about 350° C. or lower to be suitable for melt spinning into carbon fiber. While the produced materials did not exhibit such a melting point, use of catalysts to produce more aromatic materials during pyrolysis and/or thermal treatment may provide such desired DMA results. In addition, the adjustment in concentration of reactive functional groups (e.g., particularly oxygen containing groups) that result in crosslinking rather than mesophase formation may also be helpful.

While high-quality mesophase materials that would be suitable for high-modulus carbon fiber production from pyrolysis of virgin plastic materials (PP, LDPE, HDPE and LLDPE) where not achieved in this particular example, the problems noted can likely be addressed by reducing the presence of aliphatic and oxygenated groups in the plastic tars, and increasing the aromatic content of the resulting materials. Furthermore, the use of polystyrene, which already includes an aromatic structure helps with formation of the desired mesophase materials, since the polystyrene already has an inherent aromatic character that more readily forms the necessary precursor species for mesophase formation. In addition, as noted, the use of catalysts during the formation of tars from the virgin plastic materials, can also help promote the formation of aromatic compounds from primarily aliphatic feedstocks that result from polyolefin pyrolysis.

Additional work was done, to process mixtures or blends of various plastics with coal, through the pyrolysis reactor and thermal treatment system described herein, to produce mesophasic materials that may be suitable for use in forming carbon fiber, or bulk graphitic carbon.

Such work included co-pyrolysis experiments using Utah Sufco coal with linear low-density polyethylene (LLDPE) and high-impact polystyrene (HIPS). These two plastic types have differing pyrolysis chemistries and have different hydrogen transfer behaviors. Controlled secondary gas phase reactions during pyrolysis were used to induce cracking and condensation reactions among the pyrolytic tar species, with combinations of plastic and coal. Co-pyrolysis tests were performed with feed plastic percentages ranging from 10-20 wt % (the balance being coal) and pyrolysis SGR temperatures ranging from 800-900° C., and thermal treatment after pyrolysis, at about 425° C., for 3-5 hours. Analyses of the intermediate tar products showed that oxygen content and aromaticity were substantially different, depending on the plastic feedstock used. Additionally, after thermally converting the tar samples into pitch samples (e.g., using a system as shown in FIG. 2) the resulting pitch softening points and mesophase contents varied greatly depending on the starting plastic feedstock used. Most of the synergies observed in the co-pyrolysis results were negative, except for the oxygen contents. The oxygen contents were higher than expected when LLDPE was used, resulting in reactive pitches with softening points >350° C. On the other hand, oxygen contents were lower than expected when HIPS was used, resulting in less reactive pitches. Positive and negative synergies are considered to occur when values are higher than expected and lower than expected, respectively. Ultimately, the HIPS/coal blended samples created at an SGR temperature of 900° C. had reasonable softening points at or under 350° C., making them potentially suitable for mesophase pitch-based carbon fiber production. The success in creating fusible mesophase pitches from co-pyrolyzing HIPS with Utah Sufco coal is likely attributed to the fact that polystyrene is a stronger hydrogen acceptor rather than donor, which should facilitate more cracking rather than stabilizing of tar oxygen functional groups, making the tar species ultimately less reactive during thermal conversion to mesophase pitch.

Applicant's previous work demonstrated that the use of controlled secondary gas-phase reactions (SGR) in pyrolysis improved the ability of coal tar from Utah Sufco coal to form anisotropy upon thermal conversion; however, the resulting pitches had progressed beyond mesophase formation and formed infusible (i.e., non-softening) anisotropic semicokes. This behavior in the resulting pitch samples was attributed to the samples being too reactive, thus causing the premature formation of semicoke. Addition of polystyrene or another plastic may address such an issue, while also providing a possible upcycling stream for waste polystyrene or other plastics.

Hydrogen transfer during pyrolysis of carbon materials plays a vital role in stabilizing molecular free radicals, which has several important effects on the resulting pyrolysis products. During pyrolysis of feedstocks like coal or plastics, weaker chemical bonds in their macro-molecular structures will break, resulting in solid char, liquid tar, and light gaseous products. When these chemical bonds break, molecular free radicals are generated, which must be stabilized through hydrogen transfer or further reactions with other free radical sites available in the char, tar, or gaseous species. Typically, if there is insufficient hydrogen available for stabilizing free radicals in the pyrolysis of such materials, then tar species will react with other tar species, eventually leading to coke/soot formation, or they will react with char to reform more char. Thus, insufficient hydrogen can lead to larger tar species and lower liquid tar yields during such pyrolysis.

Additionally, hydrogen transfer plays an essential role during the thermal conversion of tar to mesophase pitch. During thermal treatment of tar to create mesophase pitch, complex polymerization and condensation reactions occur, which lead to the growth of mesogens (large polycyclic aromatic hydrocarbons (PAHs) ˜1200-2000 g/mol) necessary for mesophase formation. However, the pitch viscosity must remain low enough during thermal treatment to allow the mesogens to arrange and stack to form the mesophase properly. As polymerization and condensation reactions occur in the pitch, the viscosity also increases; thus, there must be a balance between pitch reactivity and viscosity to allow for mesophase formation that will have qualities suitable for melt spinning. Hydrogen transfer from chemical groups, such as naphthenic rings in pitch, are important in preventing excessive polymerization reactions, which aids in maintaining low viscosities during thermal conversion.

Co-pyrolysis with plastics is particularly intriguing for a few reasons: 1—plastic waste is an enormous challenge that our society needs to deal with, 2—there is a wide variety of plastic types with different chemical properties and structures available, and 3—most plastics are more hydrogen-rich than most coals. Due to the different chemical structures of many plastic types, they yield different products during pyrolysis. Additionally, when co-pyrolyzing plastics with other carbon materials like coal, certain plastics can act as hydrogen donors and others tend to be hydrogen acceptors. Thus, the choice of a co-pyrolysis plastic feedstock depends on the desired products.

The work described in this example tests the co-pyrolysis of Utah Sufco coal with a couple of different plastics, polyethylene and polystyrene, which have different hydrogen transfer abilities. Controlled secondary gas-phase reactions (SGR) were implemented in all of the pyrolysis experiments similar to previous work done by applicant on coal feedstocks alone; however, this work examines if there are added benefits by adding plastics to the coal in this process, particularly for creating quality, fusible mesophase pitches. To applicant's knowledge, no one has performed tests of SGR pyrolysis on mixed coal/plastic feeds. This work examines some of the chemical properties of the intermediate co-pyrolysis tar products and the thermally converted pitch products to see the impacts of adding polyethylene and polystyrene to the coal. Synergies from adding the plastics and statistical analysis of variance on the results were also performed.

The feedstock materials used for the work described were Utah Sufco coal, linear low-density polyethylene (LLDPE), and high-impact polystyrene (HIPS), the latter two of which were obtained in pellet form. LLDPE differs from standard LDPE in that the former generally have shorter alkyl branches in the polymer than the latter. HIPS is a widely used copolymer of polystyrene and 5-10% polybutadiene, which gives it higher toughness and impact resistance than pure polystyrene. Table 4 gives the elemental compositions of the feedstocks used herein. The values shown for the plastics are approximations based on their respective chemical structures.

TABLE 4

| | Elemental Analysis (wt %, daf) | | | | | |
|---|---|---|---|---|---|---|
| Sample | C | H | N | O | S | C/H (mol) |
| Utah Sufco Coal | 79.3 | 5.6 | 1.3 | 13.4 | 0.4 | 1.19 |
| LLDPE | 85.6 | 14.4 | — | — | — | 0.50 |
| HIPS^{a} | 92.1 | 7.9 | — | — | — | 0.97 |

^{a}Assuming an average of 7.5 wt % polybutadiene

The co-pyrolysis experiments were set up based on an unreplicated 2³ factorial experimental design (with replicated center points) to probe for ideal conditions more efficiently and allow for statistical analysis of variance (ANOVA) calculations. The replicated center points provided a source for error calculation and identifying any potential significant curvature in the data. The three factors tested in the factorial design were plastic type, plastic mixture percent, and SGR temperature (see Table 5 for sample details and conditions). Since one of the factors is not quantitative (i.e., plastic-type), the center points were tested for each plastic type.

The plastic pellets were physically mixed in with the coal in fractions of 10, 15, or 20 wt %, with a total mass of 300 g of coal and plastic for each co-pyrolysis test. The pyrolysis reactor used to pyrolyze the coal/plastic feedstocks was as shown in FIG. 1. The first stage of the reactor, used for primary pyrolysis of the feedstocks, was heated to 600° C. for all tests, and the second stage, used for facilitating SGR, was heated to 800-900° C. for all tests. Nitrogen was used as the inert carrier gas, where the flow rates were set to try and maintain nominal gas residence times of ˜2.5 seconds in the second stage of the reactor.

The individual components of coal or plastics were also separately pyrolyzed to identify synergies from co-pyrolyzing coal and plastic. For each feedstock type, three tests were run with one at each SGR temperature of interest (800, 850, and 900° C.) and a nominal gas residence time of ˜2.5 seconds (see Table 6). For the pure plastic pyrolysis tests a metal crucible was used to hold the plastic, which fully melts during heating, unlike the coal. Additionally, due to the rapid devolatilization nature of plastics, the primary pyrolysis temperature (i.e., 1^{st} reactor stage at 600° C.) was slightly modified for the pure plastic pyrolysis tests to maintain similar nominal gas-phase residence times as in the co-pyrolysis tests. Lower primary pyrolysis temperatures were chosen based on a series of thermogravimetric analysis (TGA) tests that were performed to slow down the rate of devolatilization of the plastics.

Once the condensable pyrolysis products (i.e., tar) were collected and filtered from each sample, the tar samples were ready for characterization and thermal conversion to mesophase pitch through the thermal treatment portion of the process.

TABLE 5

| | | | SGR | N₂ Flow | |
|---|---|---|---|---|---|
| | | Plastic | Temp | (mL/min. | Replicated? |
| Sample | Plastic | (wt %) | (° C.) | STP) | (Y/N) |
| U-10-PE-800 | LLDPE | 10 | 800 | 171 | N |
| U-20-PE-800 | LLDPE | 20 | 800 | 171 | N |
| U-15-PE-850 | LLDPE | 15 | 850 | 160 | Y |
| U-10-PE-900 | LLDPE | 10 | 900 | 147 | N |
| U-20-PE-900 | LLDPE | 20 | 900 | 147 | N |
| U-10-PS-800 | HIPS | 10 | 800 | 171 | N |
| U-20-PS-800 | HIPS | 20 | 800 | 171 | N |
| U-15-PS-850 | HIPS | 15 | 850 | 160 | Y |
| U-10-PS-900 | HIPS | 10 | 900 | 147 | N |
| U-20-PS-900 | HIPS | 20 | 900 | 147 | N |

TABLE 6

| | | | 2^{nd} Stage | |
|---|---|---|---|---|
| | | 1^{st} Stage | (SGR) | N₂ Flow |
| | | Temp | Temp | (mL/min. |
| Sample | Feedstock | (° C.) | (° C.) | STP) |
| U-800 | Utah Sufco | 600 | 800 | 171 |
| U-850 | Utah Sufco | 600 | 850 | 160 |
| U-900 | Utah Sufco | 600 | 900 | 147 |
| PE-800 | LLDPE | 460 | 800 | 171 |
| PE-850 | LLDPE | 460 | 850 | 160 |
| PE-900 | LLDPE | 460 | 900 | 147 |
| PS-800 | HIPS | 600 | 800 | 171 |
| PS-850 | HIPS | 600 | 850 | 160 |
| PS-900 | HIPS | 600 | 900 | 147 |

Several characterization techniques were employed to better understand the combined impact from pyrolysis SGR and co-pyrolysis of coal and plastic on the resulting tar products. Fourier transform infrared spectroscopy (FTIR) was used to help estimate the amount of oxygen functionality present in the tar samples. Molecular weight (MW) distributions of the tar samples were measured by laser desorption ionization mass spectrometry (LDI-MS), Proton nuclear magnetic resonance spectroscopy (H¹ NMR) was used to analyze the various fractions of hydrogen types present in the tar samples. Values from NMR analysis, such as the aromatic/aliphatic H ratio and the fraction of naphthenic protons, were of primary interest in this example to observe the overall aromaticity and the fraction of transferable hydrogen, FTH, present in the samples.

Some PAHs, such as phenanthrene are not linear or circular and have “bay” regions, which can lead to higher reactivity and impede proper molecular orientation during mesophase formation. These PAHs with bay regions can be detected by H¹ NMR (9.5-8.3 ppm, A_{bay} in Table 7). In addition to calculating the fraction of transferable hydrogen content, all other spectral regions shown in Table 7 were integrated and reported as fractions of the total measured hydrogen to compare the hydrogen distributions between samples.

TABLE 7

| | Region | Region |
|---|---|---|
| Proton description | (ppm) | Label |
| CH of bay region in polyaromatic species | 9.5-8.3 | A_{bay} |
| CH of all other aromatic species | 8.3-6.3 | Aₒₜₕ |
| R = CH₂ of olefins | 6.3-4.8 | O |
| α-CH₂ to aromatic rings (sandwiched naphthenic | 4.8-3.4 | B_{N1} |
| ring) | | |
| α-CH₂ to aromatic rings (side naphthenic ring) | 3.4-2.9 | B_{N2} |
| α-CH₂/CH₃ to aromatic rings | 2.9-2.0 | C |
| β-CH/CH₂ to aromatic rings (naphthenic and | 2.0-1.5 | D |
| methylene) | | |
| β-CH₂ to aromatic rings (methylene groups) and | 1.5-1.0 | E |
| alkyl -CH-₂ | | |
| γ-CH₃ to aromatic rings (methylene groups) and | 1.0-0.5 | F |
| alkyl R-CH₃ | | |

All tar samples collected from pyrolysis were thermally treated to create mesophase pitches. The gas sparging system and sample preparation procedures used are as shown in FIG. 2. Samples were thermally treated at 425° C. for 3 hours with nitrogen sparging. After cooling, the solid pitch samples were collected and analyzed for their softening points and anisotropy.

The samples were tested for their softening points via dynamic mechanical analysis (DMA) to determine if the mesophase pitch samples were potentially suitable for melt spinning into carbon fiber. Pitch samples were analyzed for their anisotropy using polarized microscopic images to measure their mesophase contents and optical textures.

The results indicate that co-pyrolyzing LLDPE with coal resulted in higher oxygen contents in the tar compared with HIPS. Additionally, higher percentages of LLDPE mixed in with coal also resulted in higher oxygen contents in the tar. Co-pyrolysis with HIPS resulted in much lower oxygen contents (approximately half as much as with LLDPE), which further decreased with higher mixed HIPS fractions. Oxygen contents decreased with increasing SGR temperature in samples with both types of plastic, as higher pyrolysis temperatures result in more severe cracking of functional groups.

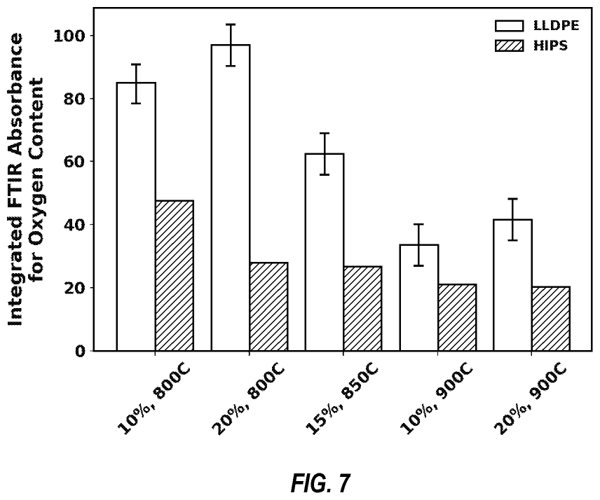

The substantial differences in the oxygen contents of the tar samples from co-pyrolysis of either LLDPE or HIPS may be explained by their relative differences in hydrogen donor/acceptor abilities. For example, the evidence indicates that polyolefins, such as polyethylene, can donate hydrogen during co-pyrolysis. On the other hand, polystyrene is a strong hydrogen acceptor. Polyethylene pyrolysis products, being potential hydrogen donors, can donate hydrogens to the tar radicals and possibly stabilize reactive oxygen functional groups before they have a chance to crack and result in cross-linking reactions. This behavior may help explain the higher oxygen contents in the coal/LLDPE tar samples. In contrast, the hydrogen acceptor ability of polystyrene during pyrolysis would lead to easier cracking and removal of coal oxygen functional groups since there is less available hydrogen to stabilize them. The final integrated oxygen values are displayed in FIG. 7, as well as Table 8 below.

TABLE 8

| | Oxygen Content |
|---|---|
| | (FTIR Integrated |
| Sample | Absorbance) |
| U-10-PE-800 | 84.7 |
| U-20-PE-800 | 97.1 |
| U-15-PE-850 #1 | 63.5 |
| U-15-PE-850 #2 | 61.5 |
| U-10-PE-900 | 33.6 |
| U-20-PE-900 | 41.5 |
| U-10-PS-800 | 47.7 |
| U-20-PS-800 | 28.1 |
| U-15-PS-850 #1 | 27.1 |
| U-15-PS-850 #2 | 26.2 |
| U-10-PS-900 | 21.1 |
| U-20-PS-900 | 20.3 |

Tar molecular weight (MW) distributions were measured with LDI-MS to determine the impact of co-pyrolyzing either LLDPE or HIPS with coal. Table 9 displays values that summarize the MW distributions (i.e., weight-averaged MW, number-averaged MW, and dispersity). Tar samples derived from co-pyrolysis with LLDPE seem to indicate the formation of slightly higher average MWs with higher concentrations of plastic in the feed but have smaller dispersity. Increasing the SGR temperature resulted in lower average MWs and higher dispersity for the LLDPE/coal tar samples. The HIPS/coal tar samples generally increased in average MW with increasing plastic concentrations and higher SGR temperatures. The HIPS co-pyrolysis tar products also have higher dispersity than the LLDPE counterparts.

Since LLDPE can act as a hydrogen donor, hydrogen transfer reactions likely led to the stabilization of coal tar radicals, ultimately suppressing the formation of larger PAHs, which would, in turn, decrease the MW dispersity. Conversely, polystyrene is a hydrogen acceptor, which likely facilitates the retention of styrene oligomers and larger PAHs' growth during pyrolysis. At higher SGR temperatures, the lower average MW in the LLDPE/coal tar samples may be attributed to the more intense cracking of the alkyl polymer chains, leading to smaller alkyl products. Furthermore, the increase in dispersity and average MW of the HIPS/coal tar samples at higher SGR temperatures is due to aromatic ring condensation reactions leading to the growth of larger PAHs in the tar.

TABLE 9

| Sample | M̅_̅{̅W̅}̅ | M̅_̅{̅N̅}̅ | Ð |
|---|---|---|---|
| U-10-PE-800 | 317 | 307 | 1.035 |
| U-20-PE-800 | 330 | 322 | 1.022 |
| U-15-PE-850 #1 | 310 | 303 | 1.024 |
| U-15-PE-850 #2 | 312 | 303 | 1.030 |
| U-10-PE-900 | 302 | 291 | 1.038 |
| U-20-PE-900 | 304 | 294 | 1.034 |
| U-10-PS-800 | 299 | 290 | 1.030 |
| U-20-PS-800 | 319 | 308 | 1.037 |
| U-15-PS-850 #1 | 314 | 302 | 1.042 |
| U-15-PS-850 #2 | 321 | 308 | 1.044 |
| U-10-PS-900 | 313 | 300 | 1.044 |
| U-20-PS-900 | 337 | 320 | 1.054 |

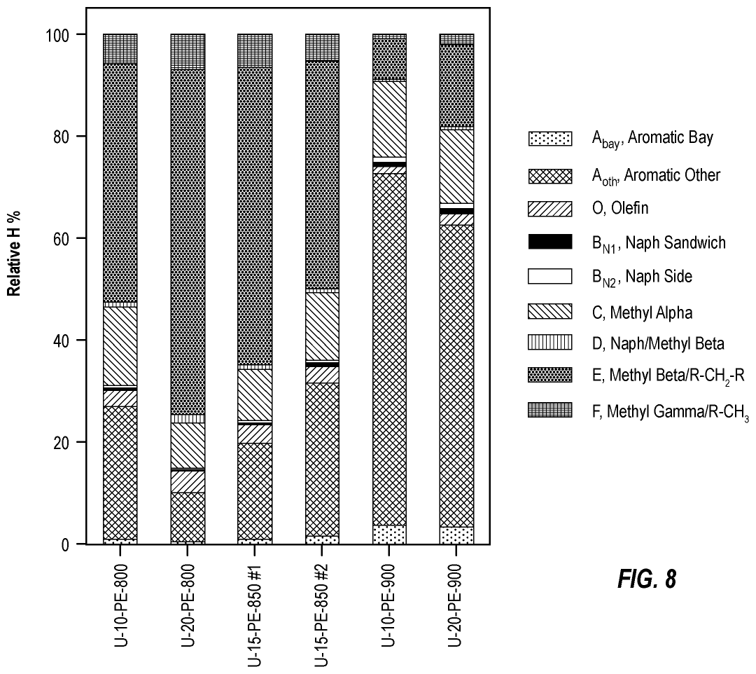

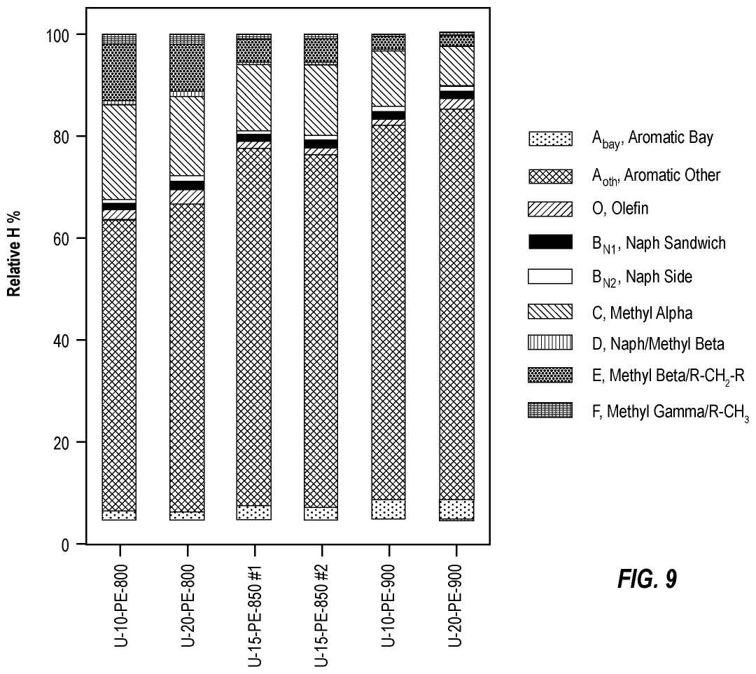

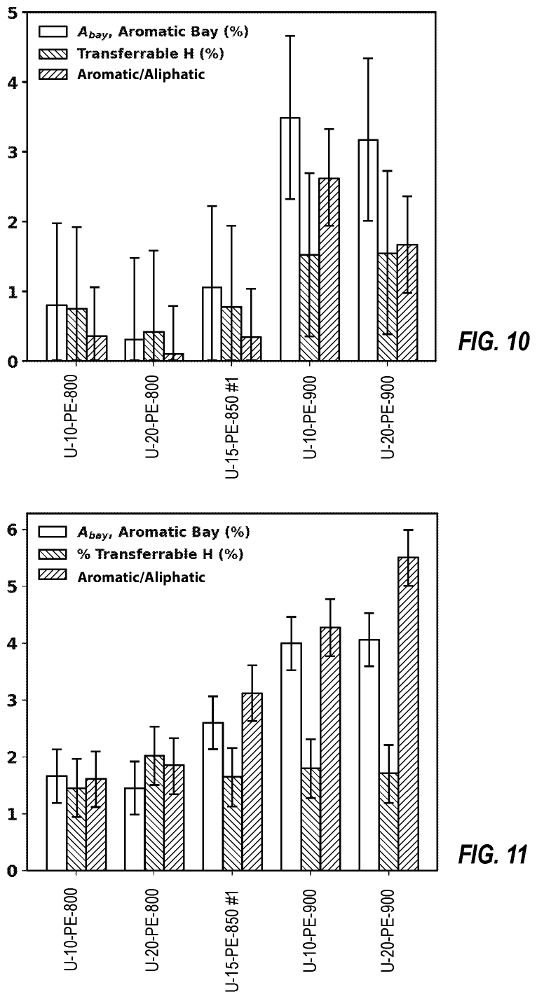

H¹ NMR was used to identify the relative concentrations of various types of hydrogens present in the tar samples. FIGS. 8 and 9 present the relative percentages of the various hydrogen types in the co-pyrolysis tar samples, where the regions were previously defined in Table 7. The NMR results indicate that the fractions of aromatic hydrogens are generally much higher in the HIPS/coal tar samples than in the LLDPE/coal tar samples, which may be explained considering the aliphatic structure of LLDPE compared with the aromatic structure of HIPS. It is important to note that the LLDPE/coal tar samples have very high percentages of hydrogens in the “E” region (1.5-1.0 ppm), which are primarily associated with alkyl R—CH₂—R hydrogens and indicate the high concentration of long-chain alkanes in those samples. FIGS. 10 and 11 further highlight the discrepancy in aromaticity between the two types of plastic/coal tar samples by showing the ratios of total aromatic to total aliphatic hydrogens. Interestingly, the aromatic-to-aliphatic ratios were <1 for the LLDPE/coal tar samples until SGR temperatures were at 900° C., after which the ratios increased substantially. This observation indicates that cracking reactions of the alkyl polymer fragments from LLDPE were not as extensive at pyrolysis temperatures below 900° C. On the other hand, the HIPS/coal tar samples all had aromatic-to-aliphatic hydrogen ratios>1 and steadily increased with increased plastic percentages and SGR temperatures.

Transferable hydrogen from naphthenic-type functional groups is important in precursors for mesophase pitch due to their ability to help stabilize free radicals and maintain relatively low viscosities during mesophase formation. FIGS. 10 and 11 display the percentage of H¹ NMR-measurable transferable hydrogen. The total transferrable hydrogen did not appear in very high percentages in the samples created herein. In the LLDPE/coal tar samples, the transferrable hydrogen content seemed to increase slightly with increasing temperature; however, in the HIPS/coal tar samples, the transferrable hydrogen content did not appear to follow a clear trend. Furthermore, the evident variation in the transferrable hydrogen contents between the replicates may suggest insignificant overall variation in transferrable hydrogen between the samples (see FIGS. 10 and 11). These results may also demonstrate the difficulty of using this approach to measure transferrable hydrogen when the content of naphthenic-type groups is relatively low. While the naphthenic-based transferrable hydrogen content may be low for these samples, these results do not preclude the potential of hydrogen transfer from other species, such as from the long-chain alkanes present in the LLDPE/coal tar samples.

The “bay”-area aromatic hydrogens (i.e., phenanthrene-type “bay”-areas) are of interest due to their supposed higher reactivity than aromatic species without “bay”-areas. FIGS. 10 and 11 demonstrate that the “bay”-area hydrogen contents increase with increasing SGR temperature for tar samples from both plastic types. Generally, the LLDPE/coal tar samples have low “bay”-area hydrogen contents for samples created at temperatures lower than 900° C.; however, the “bay”-area hydrogen contents increase substantially in the samples created at 900° C., similar to the overall aromatic contents. The increase in “bay”-area hydrogen content in the co-pyrolysis tar samples with SGR temperature is likely attributed to the more severe cracking of residual oligomers from plastic pyrolysis, thus resulting in tar samples more similar to the highly aromatic nature of pure coal tar.

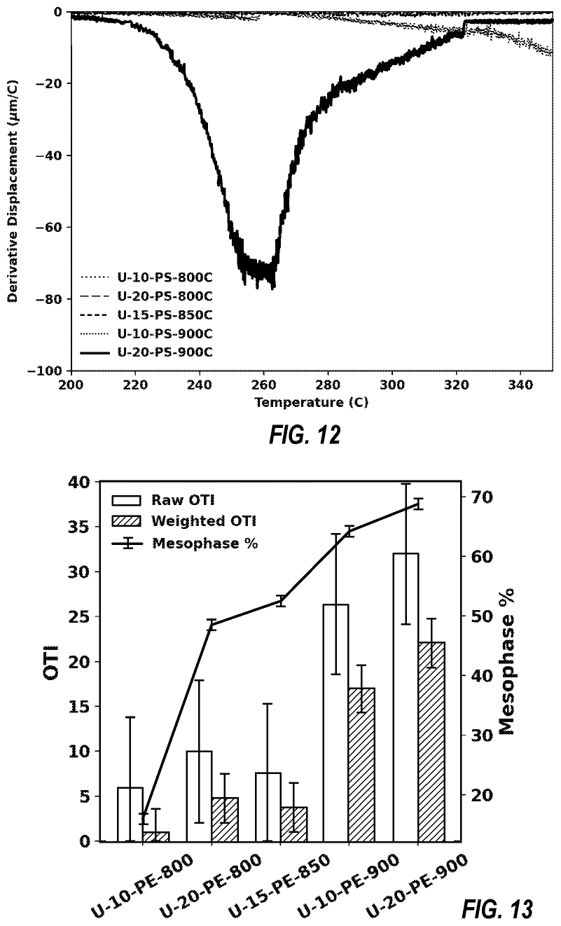

Reasonable softening points of mesophase pitches are important when considering them for carbon fiber production. A mesophase pitch sample should have a softening point lower than 350° C. to be suitable for melt-spinning into carbon fiber; otherwise, the melt spinning process will not be stable due to further chemical reactions occurring in the pitch at higher temperatures. DMA results on the pitch samples were used to estimate the pitch softening points, where the temperature of the maximum rate of change in sample height displacement is considered the softening point. FIG. 12 displays the derivative of height displacement curves for the HIPS/coal pitch samples. Of the prepared plastic/coal pitch samples, the U-20-PS-900 sample (pyrolized at 900° C., and including 20% polystyrene) exhibits a strong softening point at ˜255° C. U-10-PS-900 had a more subtle softening point, but at greater than 350° C. None of the tested LLDPE/coal pitch samples exhibited a measurable softening point at less than 350° C. (i.e., no observable derivative of displacement peaks), indicating that these samples have progressed to form semicokes and thus are not suitable for melt-spinning into carbon fiber.

The results could be explained by the oxygen contents measured in the precursor tar samples (Table 8). Tar species with high oxygen functional group substitutions lead to higher chemical reactivity. The higher reactivity leads to more rapid cross-linking/polymerization reactions between molecules, which leads to rapid MW growth and increased viscosity. These factors ultimately lead to faster progression from mesophase to semicoke. The two samples that exhibited measurable softening (U-10-PS-900 and U-20-PS-900) also had the lowest oxygen contents. As described above, it may be possible to enhance the results, to achieve a softening temperature of less than 350° C. through use of an appropriate catalyst, or further adjusting (e.g., reducing) the incidence of functional oxygen groups in the intermediate material.

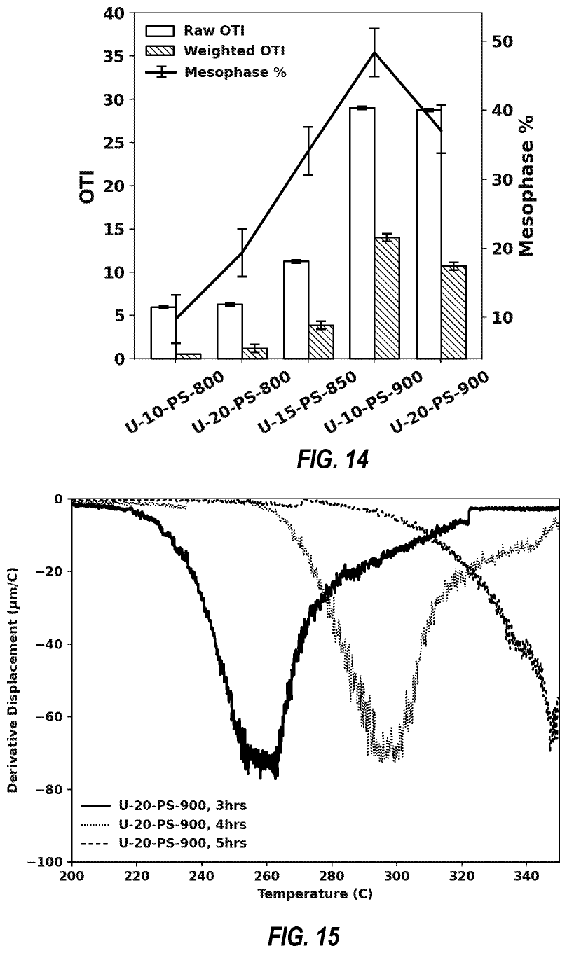

The plastic/coal pitch samples were analyzed through microscopy imaging analysis for their anisotropy. Anisotropy (i.e., mesophase) is observable under a polarized microscope, where the anisotropic domains will reflect varying bright colors (e.g., blue and yellow with the microscope used in this work) depending on the molecular orientation of structures within the mesophase. The samples were analyzed for their mesophase contents (area %) and optical texture indexes (OTI). Calculation of OTI will be familiar to those of skill in the art, and details of such are included in the provisional applications already incorporated by reference. Optical texture index (OTI) values were assigned based on analyses of polarized microscopy images of resulting anisotropic products, which were scored from 0-40, where 0 is isotropic and 40 corresponds to large domain and flow textured anisotropy. Table 10 summarizes the results of the imaging analyses, and FIGS. 13 and 14 graphically compare the imaging analyses results.

For the LLDPE/coal pitch samples, Table 10 and FIG. 13 demonstrates that mesophase content and OTI generally increase with increasing plastic feed percent and with increasing SGR temperature. Conversely, for the HIPS/coal pitch samples (FIG. 14), mesophase content increases with increasing plastic feed percent at 800° C. but decreases slightly with increasing plastic feed content at 900° C. Furthermore, the OTI for the HIPS/coal pitch samples appears to be largely unaffected by plastic feed percent and increases with increasing SGR temperature. One significant observation from plastic/coal pitch microscopy analyses demonstrates that co-pyrolysis with LLDPE results in higher overall mesophase contents than HIPS. Another significant observation is that higher SGR pyrolysis temperatures result in samples with higher quality mesophase (i.e., higher OTI), regardless of the plastic feedstock used.

TABLE 10

| | Mesophase | Raw | Weighted |
|---|---|---|---|
| Sample | % | OTI | OTI |
| U-10-PE-800 | 15.9 | 6.0 | 0.95 |
| U-20-PE-800 | 48.5 | 10.0 | 4.84 |
| U-15-PE-850 #1 | 52.6 | 6.3 | 3.33 |
| U-15-PE-850 #2 | 52.3 | 8.8 | 4.20 |
| U-10-PE-900 | 64.3 | 26.4 | 16.94 |
| U-20-PE-900 | 68.9 | 32.0 | 22.07 |
| U-10-PS-800 | 9.8 | 6.0 | 0.58 |
| U-20-PS-800 | 19.4 | 6.3 | 1.22 |
| U-15-PS-850 #1 | 33.6 | 11.2 | 3.77 |
| U-15-PS-850 #2 | 34.7 | 11.3 | 3.92 |
| U-10-PS-900 | 48.3 | 29.0 | 14.02 |
| U-20-PS-900 | 37.2 | 28.8 | 10.70 |

The microscopy results observed for the plastics/coal pitch samples can be partially explained by their respective oxygen contents. As discussed previously, oxygen functional groups are reactive and can facilitate crosslinking/polymerization reactions; thus, oxygen functionality can help and hinder mesophase formation in carbon materials. Oxygen functional groups can help mesophase formation by allowing mesogens (i.e., PAHs around 1200-2000 g/mol) to form more easily through polymerization reactions. On the other hand, oxygen functional groups can inhibit mesophase formation through excessive polymerization reactions, leading to nonplanar PAHs or too large PAHs, which facilitates high viscosity and rapid semicoke formation.

With oxygen content in mind, the high mesophase contents in the U-10-PE-900 and U-20-PE-900 pitch samples could be explained by having enough oxygen to facilitate sufficient growth of mesogens but not too much oxygen to inhibit mesophase formation. On the other hand, the LLDPE/coal pitch samples created at lower temperatures (i.e., 800, 850° C.) likely had high enough oxygen content to inhibit many mesogens from coalescing properly and forming mesophase. Ultimately, all of the tested LLDPE/coal pitch samples were still too reactive and had too much oxygen content since none of them could soften at temperatures<350° C., as already discussed. Furthermore, the HIPS/coal pitch samples all had much lower oxygen contents than the LLDPE counterparts, and they also had much lower mesophase contents. These results may indicate that the lower oxygen functionality in the HIPS/coal pitch samples led to slower growth of the mesogens needed for mesophase formation. That said, some of the HIPS/coal pitch samples showed promise for melt spinnability, by having softening temperatures of <350° C. As noted above, further improvements may be achieved through use of a catalyst, and/or reduction of oxygen functional groups.

In addition to oxygen contents, the hydrogen distributions measured by NMR can help explain the microscopy results. The rapid increase in the aromatic-to-aliphatic ratios in the LLDPE/coal tar samples created at 900° C. likely played a prominent role in the substantial increase in anisotropic contents of their respective pitches. Likewise, for the HIPS/coal samples, the observed increase in anisotropy formation corresponded with the increase in aromatic-to-aliphatic ratios, which increased with increasing SGR temperatures. Higher aromaticity means more aromatic species are available to form mesogens, which stack and coalesce to form mesophase; thus, leading to an overall improvement in the anisotropy.

It is important to consider pitch softening points and their overall anisotropy to evaluate pitch samples' suitability for melt-spinning into mesophase carbon fibers. As noted, of the tested samples, only one sample had a distinct softening point, the U-20-PS-900 pitch sample. However, this particular sample only had about 37% mesophase content, where it may be ideal to have a mesophase content between 70-80% for melt spinning into carbon fiber. Thus, additional tests were run at the same pyrolysis condition used to create the U-20-PS-900 sample. The U-20-PS-900 pyrolysis conditions were repeated two more times, but the following mesophase thermal conversion tests were run at 425° C. for 4 and 5 hours, respectively, instead of the previously used 3 hours, to see if this would increase mesophase content. By thermally treating the U-20-PS-900 tar samples for longer times, the overall mesophase contents could be increased while attempting to maintain a softening point of <350° C.

Table 11 and FIG. 15 summarize the U-20-PS-900 pitch analysis results between the three different thermal conversion reaction times. By further treating the U-20-PS-900 tar samples for longer thermal conversion times, the anisotropic content increased and improved in quality from 37% (meso %) and 28.8 (raw OTI) up to 72% (meso %) and 35.3 (raw OTI). As expected, along with an increase in the overall anisotropy, there was an increase in the pitch softening point from 257° C. to 347° C., which is still within the acceptable upper limit for melt-spinning into carbon fiber. Hence, the U-20-PS-900-5 hr pitch sample has been identified as a sample that is a potentially strong candidate for mesophase pitch-based carbon fiber production due to having a mesophase content between 70-80% and a softening point of <350° C. As noted above, other of the tested samples (PE or HIPS, or other contemplated plastics) may also be modified to meet such criteria, e.g., through use of a catalyst during SGR, and/or other steps to affect oxygen content.

TABLE 11

| | T_{SP} | Mesophase | Raw | Weighted |
|---|---|---|---|---|
| Sample | (° C.) | % | OTI | OTI |
| U-20-PS-900, 3 hour | 257 | 37.2 | 28.8 | 10.71 |
| U-20-PS-900, 4 hour | 296 | 50.9 | 30.9 | 15.73 |
| U-20-PS-900, 5 hour | 347 | 71.9 | 35.3 | 25.38 |

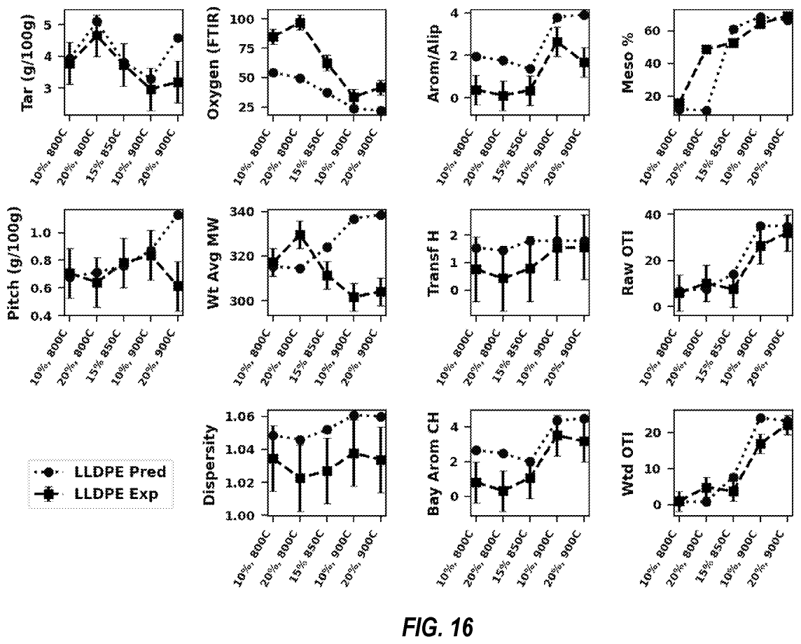

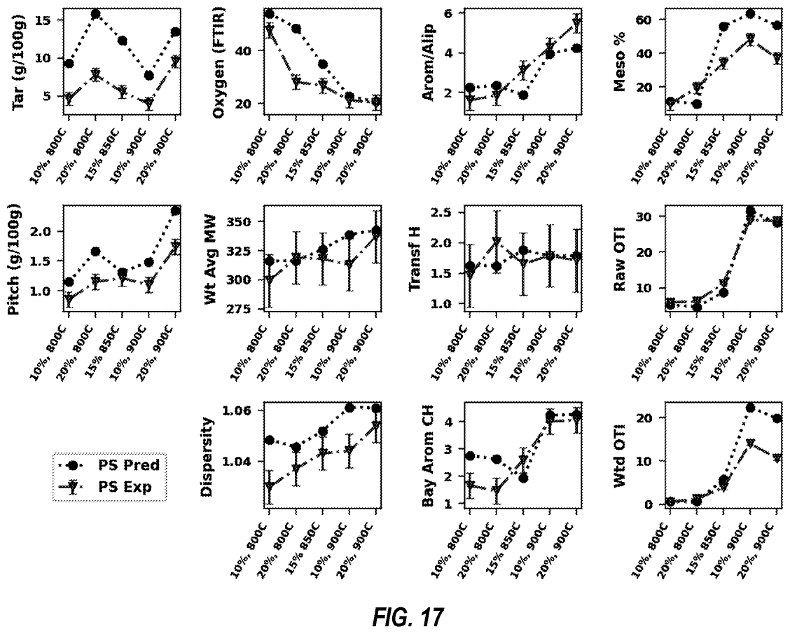

In addition to the plastic/coal co-pyrolysis tests, pure coal and plastic pyrolysis tests were also performed to compare the experimental co-pyrolysis results with the predicted co-pyrolysis results by adding the individual components together. Table 12 summarizes various measurements ranging from tar yields to mesophase contents for pure coal and pure plastic pyrolysis experiments. The values in Table 12 were used to calculate the predicted values based on a linear combination of the pure component measurements, which were then compared with the experimental values in FIG. 16 (LLDPE/coal samples) and FIG. 17 (HIPS/coal samples). Error bars in the figures indicate the 95% confidence intervals calculated from the U-15-Plastic-850 replicate samples. Comparing the co-pyrolysis experimental versus predicted results helped identify potential positive or negative synergies. Positive and negative synergies are considered to occur when values are higher than expected and lower than expected, respectively.

TABLE 12

| | | Liquid Tar Products | | | | | | | Pitch Products | | | |
|---|---|---|---|---|---|---|---|---|---|---|---|---|
| | Temp | Tar Yield [symbol] | Oxygen | Wt Avg | | Ar/ | Trans | Bay | Pitch Yield | Meso | Raw | Wtd |
| Feed | (° C.) | (g/100 g) | (FTIR) | MW | Dispersity | Ali | H | CH | (g/100 g) | (%) | OTI | OTI |
| Utah | 800 | 2.8 | 59.6 | 316 | 1.051 | 2.14 | 2.89 | 3.63 | 0.64 | 12.6 | 5.9 | 0.7 |
| Sufco | 850 | 2.1 | 40.4 | 324 | 1.054 | [symbol] .36 | [symbol] .71 | [symbol] .81 | 0.5 [symbol] | 65.8 | 10.3 | 6.8 |
| Coal | 900 | 2.0 | 24.6 | 335 | 1.062 | 3.68 | 4.21 | [symbol] .79 | 0.61 | 70.8 | 35.2 | 24.9 |
| LLDPE | 800 | 14.5 | 8.4 | 309 | 1.025 | 0.18 | 0.74 | 0.67 | 1.01 | 6.9 | 14.9 | 1.0 |
| | 850 | 13.3 | 18.7 | 324 | 1.038 | [symbol] .34 | 3.59 | [symbol] .65 | 1.95 | 35.4 | 35.2 | 12.5 |
| | 900 | 14.9 | 13.3 | 352 | 1.054 | 4.87 | 5.61 | [symbol] .7 [symbol] | 3.21 | 49.2 | 33.4 | 16.4 |
| HIPS | 800 | 68.3 | 4.4 | 319 | 1.024 | 3.19 | 1.56 | 1.59 | 5.75 | 0 | 0 | 0 |
| | 850 | 70.3 | 3.8 | 337 | 1.038 | 4.73 | 3.19 | 2.26 | 5.64 | 0 | 0 | 0 |
| | 900 | 59.7 | 4.8 | 372 | 1.059 | 6.54 | 4.47 | 1.77 | 9.33 | 0 | 0 | 0 |

[symbol]

indicates data missing or illegible when filed

From FIG. 16, it appears that there is generally a negative synergy for the LLDPE/coal samples for most measurements, except for the tar oxygen contents, where there is a positive synergy. Measurements such as tar/pitch yields and mesophase %/OTI values are reasonably well predicted within the confidence intervals, except for U-20-PE-900 tar/pitch yields. Note that experimental tar and pitch yields for the LLDPE/coal products are still higher than from pyrolyzing coal alone (see Table 12), indicating that adding LLDPE still increases the overall tar/pitch yields. Discrepancies between the experimental and predicted oxygen contents, MW/dispersity values, and aromaticity are more noticeable. Notably, oxygen and aliphatic contents in the LLDPE/coal tar samples were higher than predicted, which may be explained by hydrogen transfer from the LLDPE to the coal during pyrolysis. Hydrogen transfer from the plastic may have effectively stabilized more of the oxygen/aliphatic functional group radicals present in the coal tar, which functional groups would have otherwise cracked and been removed without sufficient hydrogen transfer. It is challenging to gauge the true synergistic nature for the MW dispersity and the transferrable hydrogen measurements of the LLDPE/coal samples due to their wide confidence intervals; however, the initial measurements seem to indicate slightly negative synergies. The U-20-PE-800 sample is another notable sample in that it is the only sample with a positive synergy for average MW and mesophase content. These results for U-20-PE-800 could be explained by the higher oxygen content of that sample, leading to more cross-linking/polymerization reactions and MW growth. The larger average MW of this sample could then lead to the easier formation of mesogens necessary for mesophase formation.

The HIPS/coal samples have a similar general negative synergy as the LLDPE/coal samples, in that the experimental values were lower than expected based on the linear combinations of their respective pure-component values (see FIG. 17). For most of the measurements, it appears that the negative synergy decreases with increasing plastic content or SGR temperature, except for mesophase % and OTI values. Notably, the oxygen content synergy in the HIPS/coal tar samples is opposite from the LLDPE/coal tar samples, which is likely explained by hydrogen transfer from the coal to the plastic. Transferring hydrogen from the coal to the plastic would result in more cracking of oxygen functional group radicals, thus leading to lower oxygen contents than expected. The lower tar/pitch yields could also be explained by hydrogen transfer. Since polystyrene is a strong hydrogen acceptor, the pyrolytic species from pure HIPS pyrolysis would have to abstract hydrogen from itself, leading to high yields of light and heavy tar products through cracking and polymerization reactions (see Table 12). However, upon adding a hydrogen donor (i.e., coal) to HIPS during pyrolysis, the hydrogen transfer from coal will stabilize smaller HIPS pyrolysis products and inhibit the formation of larger polymerized species. The negative synergies of the mesophase % and OTI values at 900° C. can be explained by those samples' much lower oxygen contents. It is more challenging to polymerize the coal tar species into larger mesogens necessary for mesophase formation by having low oxygen contents. Lastly, there did not appear to be significant deviations in the average MW, aromaticity, or the transferrable hydrogen content from the predicted values.

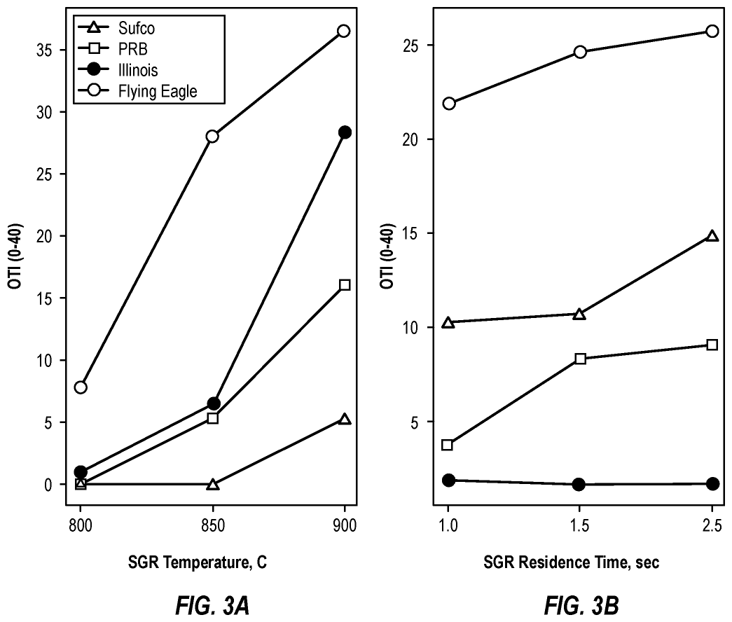

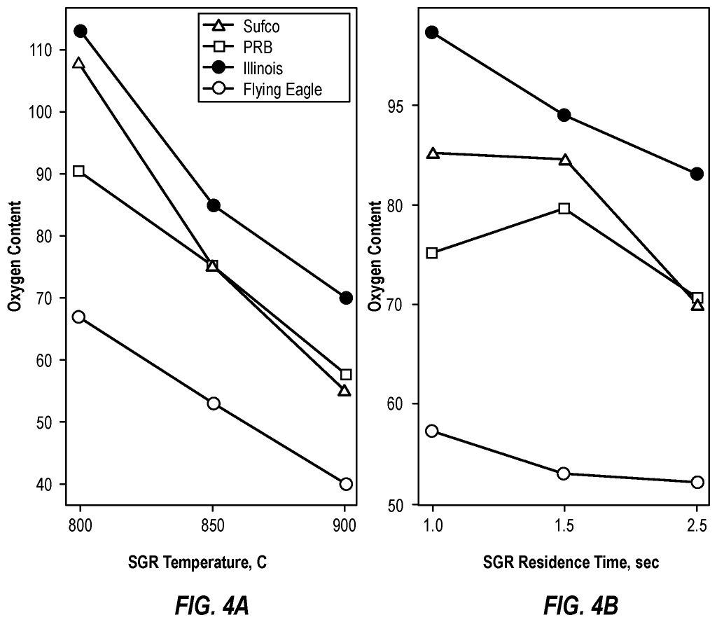

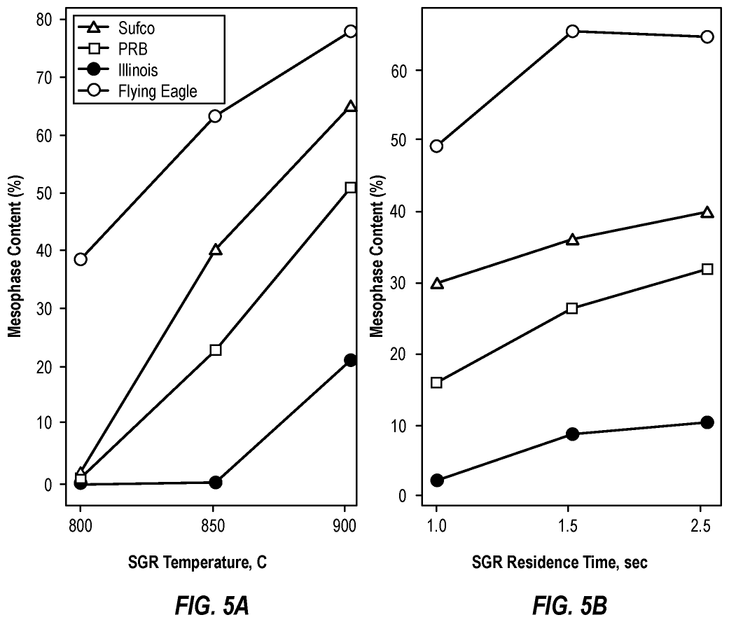

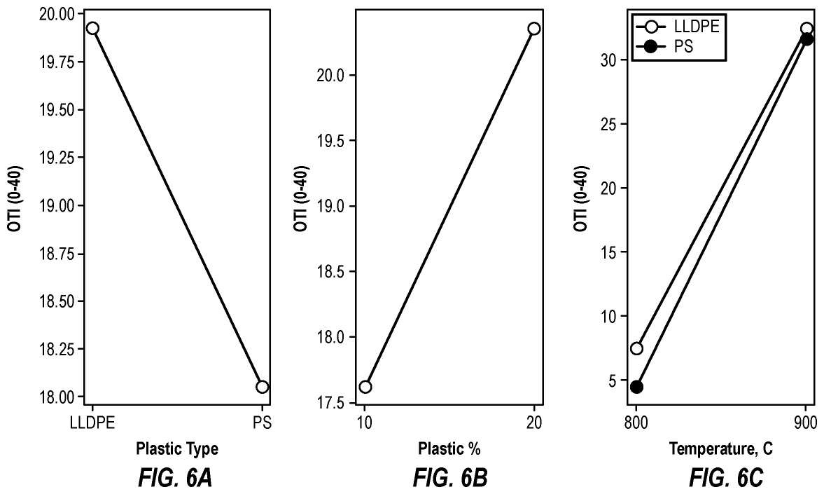

Part of the reason for setting up a factorial design of experiments for the co-pyrolysis tests was to allow for statistical analysis of variance (ANOVA) calculations to help identify which of the experimental factors had statistically significant impacts on the resulting product properties. Statistical analyses, such as ANOVA, can be used to support conclusions that are otherwise based on scientific principles. FIGS. 3A-6C present effects plots for many of the various co-pyrolysis product measurements. These plots help illustrate the general impacts of the sources of variation (e.g., effects A, B, C, etc.) on the sample properties.

Using the replicated center points (U-15-PE-850 or U-15-PS-850 samples) of the factorial design as the source for error, ANOVA was performed for each product measurement of interest. Table 13 presents the resulting p-values from ANOVA on these measurements, where the sources of controlled variation are plastic-type (effect A: LLDPE or HIPS), plastic percent of feed (effect B: 10 or 20 wt %), and SGR temperature (effect C: 800 or 900° C.). Due to the potential for significant interactions between the controlled sources of variation, Table 13 includes p-values for interaction effects, such as AB, AC, etc. Lastly, Table 13 also includes ANOVA for quadratic curvature, where the center points of the factorial design can help identify if there is significant curvature in the data or not. Since there is a small number of factorial points used in this work (i.e., 8 points, with four replicate center points), sources of variation (i.e., A, B, C, etc.) were considered to be significant if their corresponding p-values were less than 0.10 (i.e., a significance level of α=0.10) to reduce the chance for Type II error (not rejecting the null hypothesis when the null hypothesis is false).

Based on the significance level chose for this work (i.e., α=0.10), the main effects of plastic-type (A), plastic percent (B), and SGR temperature (C) had significant impacts on various measured properties. Plastic-type (A) was considered to significantly impact tar yields, oxygen contents, pitch yields, and mesophase contents. These results are consistent with what was observed and discussed previously. FIGS. 16 and 17 showed the substantially different tar/pitch yields produced from co-pyrolysis of LLDPE/coal and HIPS/coal. As discussed herein, the plastic-type certainly has a substantial impact on the resulting oxygen content, as well as mesophase content of the pitch products derived from the different tested plastics.

Plastic percent of the feed (B) was considered to only significantly impact tar yield and the average tar MW. Looking closely at FIGS. 16 and 17, it is clear that having higher plastic contents in the feed results in higher tar yields. Additionally, it is clear that upon increasing the plastic content in the feed, the average tar MW also increases.

SGR pyrolysis temperature (C) significantly impacted oxygen contents, aromaticity (“bay”-area H), mesophase contents, and OTI values. The results described herein all demonstrate the impact of SGR temperature on the co-pyrolysis products. The impact of SGR temperature and SGR residence time on OTI, oxygen content, and mesophase content is also shown for various coal types in FIGS. 3A-3B, 4A-4B, and 5A-5B.

TABLE 13

| | P-Values | | | | | | | | | |
|---|---|---|---|---|---|---|---|---|---|---|
| Source of | Tar | Qxy | Wt Avg | | Arom/ | | | Pitch | Meso | Raw |
| Variation | Yield | Cont | MW | Dispersity | Alip | Trans H | Bay H | Yield | % | OTI |
| A (Plastic Type) | 0.032 | 0.097 | 0.330 | 0.277 | 0.159 | 0.171 | 0.277 | 0.061 | 0.070 | 0.561 |
| B (Plastic %) | 0.047 | 0.999 | 0.022 | 0.970 | 0.961 | 0.912 | 0.734 | 0.425 | 0.320 | 0.240 |
| C (SGR Temp) | 0.729 | 0.096 | 0.541 | 0.197 | 0.112 | 0.292 | 0.026 | 0.272 | 0.025 | 0.001 |
| AB | 0.08 [symbol] | 0.537 | 0.116 | 0.316 | 0.596 | 0.641 | 0.809 | 0.178 | 0.287 | 0.245 |
| AC | 0.339 | 0.304 | 0.012 | 0.588 | 0.620 | 0.301 | 0.826 | 0.373 | 0.709 | 0.677 |
| BC | 0.602 | 0.822 | 0.701 | 0.725 | 0.955 | 0.864 | 0.877 | 0.810 | 0.203 | 0.880 |
| ABC | 0.386 | 0.718 | 0.366 | 0.862 | 0.736 | 0.554 | 0.974 | 0.528 | 0.825 | 0.763 |
| Quad Curvature | 0.548 | 0.875 | 0. [symbol] 9 | 0.809 | 0.635 | 0.588 | 0.397 | 0.810 | 0.557 | 0.009 |

[symbol]

indicates data missing or illegible when filed

Outside of the main effects (A, B, and C), only two interaction effects were identified as being significant: AB and AC. The AB interaction effect suggests that plastic type (A) and plastic percent (B) may be synergistic. The AB interaction was indicated to only have a significant effect on tar yield, where it can be seen from FIGS. 16 and 17 that increasing plastic percent does not affect tar yields from both plastic types equally. In other words, increasing plastic percent impacts tar yields from HIPS/coal pyrolysis more strongly than for LLDPE/coal pyrolysis. The AC interaction effect suggests that there could be a synergistic interaction between plastic-type (A) and SGR temperature (C). The AC interaction effect was only identified to significantly impact the weight-averaged MW, where it can be seen from FIGS. 16 and 17, that SGR temperature has a contrasting effect on the average MW depending on the plastic being used. At high SGR temperatures, the average MW decreases for LLDPE/coal tar samples, whereas the average MW increases for HIPS/coal tar samples.

Lastly, quadratic curvature was only significant for the raw OTI measurements. It is clear from FIGS. 16 and 17 that the OTI increases slowly at 800 and 850° C., but then rapidly increases at 900° C. for both plastic-type co-pyrolysis products; thus, the OTI results are non-linear within the range of reaction conditions tested in this work.

The p-values resulting from ANOVA calculations demonstrated in Table 13 provide insight into which controlled reaction conditions (i.e., plastic-type, plastic percent, and SGR temperature) may have statistically significant impacts on specific product properties. Based on the statistical results presented in this section and the results presented in the previous sections, co-pyrolysis of plastics with coal could generally be summarized by the following points:

LLDPE leads to lower tar/pitch yields than HIPS;
LLDPE leads to higher tar oxygen and aliphatic contents;
HIPS leads to lower tar oxygen contents and lower mesophase contents;
Increasing plastic percentage in the feed leads to higher tar yields and higher average MW; and
Increasing SGR temperature leads to decreased oxygen content, increased aromaticity, increased mesophase content, and increased OTI values.

The liquid products from 2-stage pyrolysis tests were collected, followed by thermal treatment of such products in a sparging reactor to create anisotropic carbon materials, suitable for use in manufacture of high-modulus carbon fiber, or bulk graphite (e.g., for battery electrode materials).

It is to be understood that features described with regard to the various embodiments herein may be mixed and matched in any desired combination. In addition, the concepts disclosed or envisioned herein may be embodied in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A method for producing mesophasic carbon material, the method comprising:
subjecting a carbon feedstock material to pyrolysis within a 2-stage pyrolysis reactor including a first pyrolysis stage and a second pyrolysis stage, wherein the carbon feedstock material comprises a plastic material;
wherein the first pyrolysis stage subjects the carbon feedstock material to pyrolysis gas phase reactions at a first temperature and the second pyrolysis stage operates at a second temperature that is higher than the first temperature; and
subjecting pyrolysis products from the 2-stage pyrolysis reactor to a sparging and thermal treatment stage, in which the pyrolysis products from the 2-stage pyrolysis reactor are converted from pyrolysis tar products to an anisotropic pitch product suitable for use in production of carbon fiber or bulk graphite for use in fabrication of graphite electrodes.

2. The method of claim 1, wherein the plastic material is a waste plastic material.

3. The method of claim 2, wherein the waste plastic material comprises at least one of polystyrene, polyethylene, or polypropylene.

4. The method of claim 1, wherein the first and second pyrolysis stages, and/or the sparging and thermal treatment stage are conducted under an inert atmosphere.

5. The method of claim 1, wherein the first pyrolysis stage has a temperature of from 500° C. to 700° C.

6. The method of claim 1, wherein the first pyrolysis stage operates at a temperature of about 600° C.

7. The method of claim 1, wherein the second pyrolysis stage has a temperature of from 800° C. to 1000° C.

8. The method of claim 1, wherein the second pyrolysis stage operates at a temperature of about 900° C.

9. The method of claim 1, wherein the anisotropic pitch product has an OTI of at least 10 on a scale of 0-40.

10. The method of claim 1, wherein the anisotropic pitch product has an OTI of at least 20 on a scale of 0-40.

11. The method of claim 1, wherein the anisotropic pitch product has an OTI of at least 30 on a scale of 0-40.

12. The method of claim 1, wherein the carbon feedstock material comprises at least 5% plastic waste material.

13. The method of claim 1, wherein the carbon feedstock material comprises at least 10% plastic waste material.

14. The method of claim 1, wherein the carbon feedstock material comprises at least 20% plastic waste material.

15. The method of claim 1, wherein the carbon feedstock material comprises both plastic waste material and coal.

16. The method of claim 1, wherein a residence time of the carbon feedstock material in the 2-stage pyrolysis reactor, or within the second pyrolysis stage of the 2-stage pyrolysis reactor is no more than 10 seconds.

17. The method of claim 1, wherein a residence time of the carbon feedstock material in the second stage of the 2-stage pyrolysis reactor is no more than 5 seconds.

18. The method of claim 1, further comprising condensing the pyrolysis products from the second pyrolysis stage before subjecting the pyrolysis products from the 2-stage pyrolysis reactor to a sparging and thermal treatment stage.

19. A method for producing mesophasic carbon material, the method comprising:
subjecting a carbon feedstock material to pyrolysis within a 2-stage pyrolysis reactor, the 2-stage pyrolysis reactor including a first pyrolysis stage and a second pyrolysis stage, wherein the carbon feedstock material comprises a waste plastic material;
wherein the first pyrolysis stage subjects the carbon feedstock material to pyrolysis at a first temperature in a range of 500° C. to 700° C., and the second pyrolysis stage subjects material exiting from the first pyrolysis stage to secondary gas phase reactions, at a second temperature in a range of 800° C. to 1000° C., wherein a residence time of the carbon feedstock material in the second stage of the 2-stage pyrolysis reactor is no more than 10 seconds; and
subjecting pyrolysis products from the 2-stage pyrolysis reactor to a sparging and thermal treatment stage, in which the pyrolysis products from the 2-stage pyrolysis reactor are converted from pyrolysis tar products to an anisotropic pitch product suitable for use in production of carbon fiber or bulk graphite for use in fabrication of graphite electrodes.

20. A system for producing anisotropic, mesophasic carbon material from waste plastic, the system comprising:
a 2-stage pyrolysis reactor configured to subject a carbon feedstock material to pyrolysis, the 2-stage pyrolysis reactor including a first pyrolysis stage and a second pyrolysis stage, wherein the carbon feedstock material comprises a plastic waste material;
wherein the first pyrolysis stage subjects the carbon feedstock material to pyrolysis gas phase reactions at a first temperature in a range of 500° C. to 700° C., and the second pyrolysis stage operates at a second temperature in a range of 800° C. to 1000° C., wherein a residence time of the carbon feedstock material in the 2-stage pyrolysis reactor, or in the second pyrolysis stage of the 2-stage pyrolysis reactor is no more than 10 seconds; and
a sparging and thermal treatment stage, in which condensed pyrolysis products from the second pyrolysis stage are converted from pyrolysis tar products to an anisotropic pitch product suitable for use in production of carbon fiber or bulk graphite for use in fabrication of graphite electrodes.
